(19) United States
(12) Patent Application Publication
(10) Pub. No.: US 2015/0232152 A1
(43) Pub. Date: Aug. 20, 2015

(54) Cleat

(71) Applicant: Railblaza Limited, Silverdale (NZ)

(72) Inventor: Ross Gregory Pratt, Hibiscus Coast (NZ)

(21) Appl. No.: 14/614,494

(22) Filed: Feb. 5, 2015

(30) Foreign Application Priority Data
Feb. 14, 2014 (NZ) 621286

(51) Int. Cl. B63B 21/04; A01K 97/10

(52) U.S. Cl. CPC B63B 21/045; A01K 97/10

(57) ABSTRACT

A cleat comprises an accessories mount having an accessories receiving recess, and a cleat body having a fitting recess complimentary to the accessories receiving recess. The cleat is formed such that the accessories receiving recess can be located within the cleat body's fitting recess to present the accessories receiving recess for receiving and supporting a vehicle accessory.

### FIELD OF INVENTION

This invention relates to a cleat, for example a cleat for use with watercraft. However it should be understood that in some embodiments of the invention the cleat may have other uses.

### BACKGROUND

It is known for watercraft, for example boats, to have a cleat fastened to their exterior to enable the craft to be tied to a pier, jetty, anchor or the like. A rope is wrapped around the cleat at one end, and the other end is tied at a stationary position. In some cases cleats may be used to secure a rope running from one part of a watercraft to another part, for example from cleat to cleat, or from a cleat to an on-board fixture. It is an object of a preferred form of the invention to provide a cleat which has multi-purpose functionality in that it can also be used as a mount for boating accessories. While this object applies to the preferred embodiment, it should not be seen as a limit on the scope of the invention per se. The object of the invention in general terms is simply to provide the public with a useful choice.

### SUMMARY OF THE INVENTION

According to one aspect of the invention there is provided a cleat comprising:
an accessories mount having an accessories receiving recess; and
a cleat body having a fitting recess complimentary to the accessories mount;

the cleat formed such that the accessories mount can be located within the cleat body's fitting recess such that the mount and the fitting recess are at least generally centrally aligned when in normal use to present the accessories receiving recess for receiving and supporting a vehicle accessory.

Preferably the vehicle accessory is a boat accessory.

Optionally the cleat body has a pair of arms which extend outwards in different directions to one another and are suitable for receiving rope or cord in a normal cleat wrapping fashion.

Preferably the mount and the cleat body have complimentary apertures, and such that fixing members (e.g. screws) can be driven through the apertures from the mount to hold the cleat on a vehicle with the cleat body sandwiched between the mount and the vehicle.

Preferably the vehicle is a boat.

Preferably the mount on the one hand, and the cleat body on the other, are separate pieces and can be removed from one another if desired.

Preferably the accessories receiving recess comprises a portion that is a zigzag shape.

Optionally the accessories receiving recess is star shaped.

Preferably the mount has a lock which can be activated to prevent removal of an accessory from the mount when desired.

Optionally the cleat is installed on a vehicle.

Optionally the cleat is installed on a boat.

Optionally an accessory is releasably locked into the mount.

According to a further aspect of the invention there is provided a cleat comprising:
a) an accessories mount having an accessories receiving recess and a lock which can be activated to prevent removal of an accessory from the mount when desired; and
b) a cleat body having a fitting recess complimentary to the accessories mount and having a pair of arms which extend outwardly in different directions to one another and are suitable for receiving rope or cord in a normal cleat wrapping fashion;

wherein the mount on the one hand, and the cleat body on the other, are separate pieces and can be removed from one another if desired;

the cleat formed such that:
the accessories mount can be located within the cleat body's fitting recess such that the mount and the fitting recess are at least generally centrally aligned when in normal use to present the accessories receiving recess for receiving and supporting a vehicle accessory; and
the mount and the cleat body have complimentary apertures adapted for receiving fixing members through the apertures from the mount to hold the cleat on a vehicle with the cleat body sandwiched between the mount and the vehicle.

Optionally the accessories receiving recess has a generally star-shaped internal profile.

Optionally the accessories receiving recess has a generally zig-zag shaped internal wall region.

### BRIEF DESCRIPTION OF THE IMAGES

Some preferred embodiments of the invention will now be described by way of example and with reference to the accompanying images, of which:

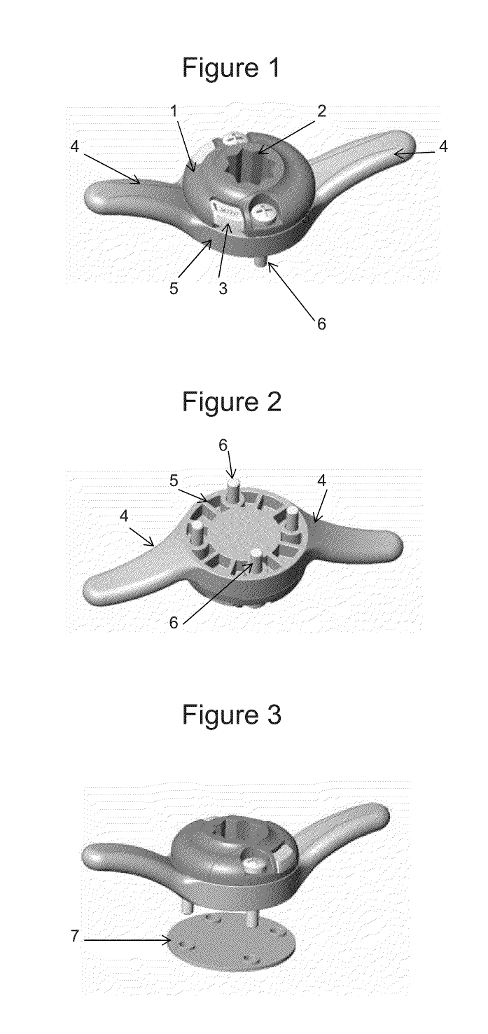

FIG. 1 is an isometric view of a cleat suitable for use in boating, shown from above;

FIG. 2 is an isometric view of the underside of the cleat;

FIG. 3 is an isometric view of the cleat when combined with a washer;

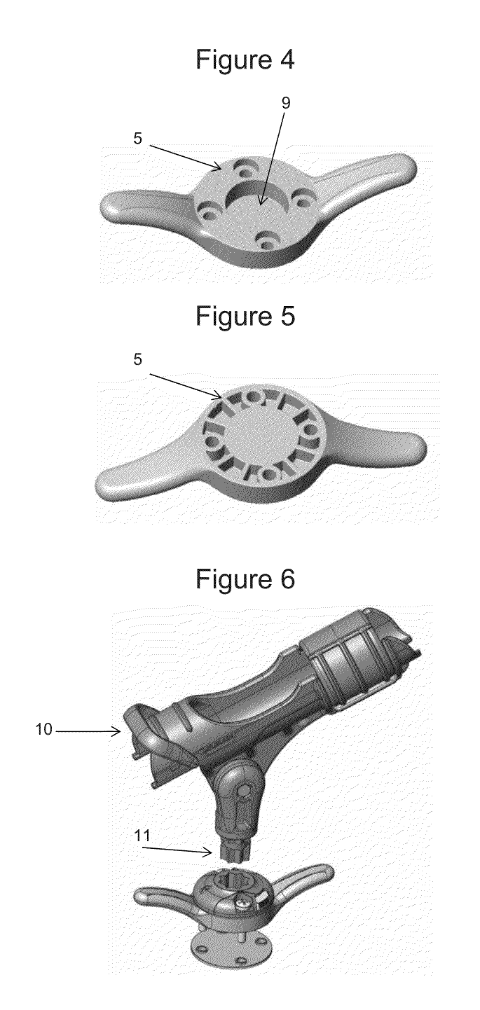

FIG. 4 is an isometric view of a base part of the cleat, shown from above;

FIG. 5 is an isometric view of the underside of the base part; and

FIG. 6 is an isometric view illustrating the cleat about to receive a boating accessory.

### DETAILED DESCRIPTION

Referring to FIGS. 1 and 2, the cleat has an upper mount 1 adapted for receiving and holding boating accessories. As shown, the mount has a star shaped recess 2 which is designed to compliment and receive a star shaped shaft of each accessory. The accessories can for example include a fishing rod holder, a table top, a camera boom, a safety flag pole, a clevis, a clamp, a cup holder, a hook, a light, etc. The mount has a locking tab 3 which can be moved by hand to releasable lock in place the particular accessory being held.

The cleat has a pair of wing like outwardly extending arms 4. These are arranged to enable one end of a rope (not shown) or the like to be wrapped around them in a normal cleat wrap fashion, for example in a figure “8” pattern. The other end of the rope can be tied to whatever one needs to tie it to, for example an anchor, a mooring or part of a boat generally. As shown, the arms 4 extend from a base 5.

The cleat can be fitted to a boat (not shown) by drilling screw holes in a part of the boat which is clear of the waterline. The cleat is then fastened by way of screws 6 and nuts (not shown). More specifically, the upper mount 1 is placed on the base 5. As shown, the mount 1 fits within the outer periphery of the base 5. The screws are then passed through holes in the mount 1, through corresponding holes in the base 5, and through a surface of the boat. The nuts are then tightened on the screws 6 to hold the cleat firmly against the boat.

Referring to FIG. 3, preferably the cleat incorporates a flexible washer 7 to facilitate a tight fit between the boat and the base 5. FIGS. 4 and 5 show the base 5, from above and below. As indicated, the arms 4 arc upwards to make it easier to work the rope around them. The base has a central recess 9 for receiving the mount 1, arranged to make space for the star shaped recess 2 of the mount.

FIG. 6 illustrates the cleat when it is about to receive a boating accessory, namely a fishing rod holder 10. As can be seen, the star shape of the rod holder's shank 11 is designed complimentary to the shape of the mount's star shaped recess 2. The arrangement is such that the arms 4 can receive a normal cleat wrap of rope without impeding the functionality of the mount 1 to hold an accessory at the same time.

In alternative embodiments of the invention the cleat may be other than the two armed variety illustrated. Essentially any suitable cleat type may be used.

While some preferred embodiments of the invention have been described by way of example it should be appreciated that modifications and improvements can occur without departing from the scope of the following claims.

1. A cleat comprising:
an accessories mount having an accessories receiving recess; and
a cleat body having a fitting recess complimentary to the accessories mount;
the cleat formed such that the accessories mount can be located within the cleat body's fitting recess such that the mount and the fitting recess are at least generally centrally aligned when in normal use to present the accessories receiving recess for receiving and supporting a vehicle accessory.

2. A cleat according to claim 1, wherein the vehicle accessory is a boat accessory.

3. A cleat according to claim 1, wherein the cleat body has a pair of arms which extend outwards in different directions to one another and are suitable for receiving rope or cord in a normal cleat wrapping fashion.

4. A cleat according to claim 1, formed so that the mount and the cleat body have complimentary apertures, and such that fixing members can be driven through the apertures from the mount to hold the cleat on a vehicle with the cleat body sandwiched between the mount and the vehicle.

5. A cleat according to claim 4, wherein the vehicle is a boat.

6. A cleat according to claim 1, wherein the mount on the one hand, and the cleat body on the other, are separate pieces and can be removed from one another if desired.

7. A cleat according to claim 1, wherein the accessories receiving recess comprises a portion that is a zigzag shape.

8. A cleat according to claim 1, wherein the accessories receiving recess is star shaped.

9. A cleat according to claim 1, wherein the mount has a lock which can be activated to prevent removal of an accessory from the mount when desired.

10. A cleat according to claim 1, installed on a vehicle.

11. A cleat according to claim 1, installed on a boat.

12. A cleat according to claim 1, wherein an accessory is releasably locked into the mount.

13. A cleat comprising:
a) an accessories mount having an accessories receiving recess and a lock which can be activated to prevent removal of an accessory from the mount when desired; and
b) a cleat body having a fitting recess complimentary to the accessories mount and having a pair of arms which extend outwardly in different directions to one another and are suitable for receiving rope or cord in a normal cleat wrapping fashion;
wherein the mount on the one hand, and the cleat body on the other, are separate pieces and can be removed from one another if desired;
the cleat formed such that:
the accessories mount can be located within the cleat body's fitting recess such that the mount and the fitting recess are at least generally centrally aligned when in normal use to present the accessories receiving recess for receiving and supporting a vehicle accessory; and
the mount and the cleat body have complimentary apertures adapted for receiving fixing members through the apertures from the mount to hold the cleat on a vehicle with the cleat body sandwiched between the mount and the vehicle.

14. A cleat according to claim 13 wherein the accessories receiving recess has a generally star-shaped internal profile.

15. A cleat according to claim 13 wherein the accessories receiving recess has a generally zig-zag shaped internal wall region.
